(19) United States
(12) Patent Application Publication
(10) Pub. No.: US 2010/0174997 A1
(43) Pub. Date: Jul. 8, 2010

(54) COLLABORATIVE DOCUMENTS EXPOSING OR OTHERWISE UTILIZING BONA FIDES OF CONTENT CONTRIBUTORS

(75) Inventors: PATRICK J. O'SULLIVAN, BALLSBRIDGE (IE); EDITH H. STERN, YORKTOWN HEIGHTS, NY (US); BARRY E. WILLNER, BRIARCLIFF MANOR, NY (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/348,174

(22) Filed: Jan. 2, 2009

(51) Int. Cl. G06F 3/00

(52) U.S. Cl. 715/751

(57) ABSTRACT

Content to be included within an electronic document associated with a content author can be determined. Bona fide information of the content author can also be determined. A request for the electronic document can be received from at least one content consumer. Responsive to the request, a copy of the requested electronic document can be provided to the content consumer. The content consumer can be provided with an indication of the bona fide information related to at least one content author associated with the electronic document.

### BACKGROUND

The present invention relates to the field of collaborative technologies for electronic documents and, more particularly, to collaborative documents exposing or otherwise utilizing bona fides of content contributors.

Communal composition of shared information is a linchpin of Web 2.0 solutions and of any collaborative effort involving electronic documents. In a Web 2.0 environment, instead of a collaborative document representing content authored from a centralized source that is published or served to others, each content recipient is potentially a content author or content modifier. WIKI technology is one Web 2.0 technology well suited to capture the wisdom of crowds. That is, WIKIs permit a community of users to create and edit Web content, which others can search and access. WIKIs are just one technology for collaborating on electronic documents and although used as an illustrative example to emphasize weaknesses and/or problems present in current implementations, these weaknesses exist for other collaboration technologies, which are to be considered as within the scope of this disclosure

To illustrate, WIKIPEDIA, which is an extensive and popular Web encyclopedia, is often touted as proof of a fundamental soundness of WIKI technology and its underlying principles. WIKI technology has been successfully utilized in such diverse areas as an encyclopedia (e.g., WIKIPEDIA), strategy (e.g., the RESEARCH STRATEGY WIKI), a planning committee (e.g., Science Fiction Convention Committee, community boards (e.g., homeowner association WIKIs, organization WIKIs, community event WIKIs, etc.), product/service feedback WIKIs, and others.

One potential weakness with WIKIs and other collaborative technologies relates to anonymous entries, meaning that an authorship of a line item or entry within a WIKI is often unknown. In some cases, access controls may allow only a small population to have the ability to modify a document, but within that community, the author is often unknown. Even if there is an indication that an author has modified a WIKI page (or other collaborative document), the bona fides of the author are neither easily available nor validated. Hence, a reader of authored content is generally unaware of source(s) of content and tend to treat, by default, all content presented within a WIKI or other collaborative document as being equally trustworthy. This assumption is often incorrect, as an ease of content authoring using WIKI and other collaborative technologies permits anyone, regardless of background, to author content on any subject.

### BRIEF SUMMARY

In one embodiment, a method or computer program product for document collaboration can exist, where content to be included within an electronic document associated with a content author can be determined. Bona fide information of the content author can also be determined. A request for the electronic document can be received from at least one content consumer. Responsive to the request, a copy of the requested electronic document can be provided to the content consumer. The content consumer can be provided with an indication of the bona fide information related to at least one content author associated with the electronic document.

In one embodiment, a system for document collaboration can include a collaboration repository, a bona fide repository, and a collaboration server. The collaboration repository can maintain a set of shared electronic documents. Each of the shared electronic documents can include content provided by at least one content author. A linkage can be maintained between content of each electronic document and a corresponding content author. The bona fide repository can maintain bona fide information of content authors. The collaboration server can provide electronic documents from the collaboration repository to content consumers responsive to document requests. The collaboration server can further automatically provide bona fide data of content authors linked to provided electronic documents responsive to document requests.

### BRIEF DESCRIPTION OF THE SEVERAL VIEWS OF THE DRAWINGS

FIG. 1 is a schematic diagram of a system for exposing or otherwise utilizing bona fide information in a collaborative document context in accordance with an embodiment of the inventive arrangements disclosed herein.

FIG. 2 is a flow chart of a method for acquiring bona fide information of a content author and associating the bona fide data with related content stored in a shared content repository in accordance with an embodiment of the inventive arrangements disclosed herein.

FIG. 3 is a flow chart of a method for presenting bona fide data of content authors to content consumers in accordance with an embodiment of the inventive arrangements disclosed herein.

### DETAILED DESCRIPTION

The present disclosure exposes or otherwise utilizes bona-fides of content authors of collaborative documents, where the bona-fides are used to provide content consumers with an indication of a level of trustworthiness to be ascribed to the contributed content. Collaborative documents can include Web 2.0 documents (e.g., WIKIs, BLOGS, discussion comments, etc.) and other documents having communal composition. Bona fides can be acquired in different ways, which include manual input by a content author, by interrogating a set of one or more database or other user information sources, by interactive questioning, by consulting an identity service, and the like. Bona fides can be optionally verified. Authorized content can be presented in a manner that presents an indication of the bona fides. In one embodiment, actual author identity can remain anonymous or hidden to viewers of the authored content, even when such information is used in conjunction with verifying the bona fides. Thus, a balance can be achieved between protecting an author's identity and/or privacy and providing a level of assurance that content is being provided by a trustworthy source.

Bona fides can include credentials, characteristics, and other particulars of an author. The bona-fides can be compared or applied in a document specific manner based upon semantic content of a related document. For example, bona-fides applicable for an event that occurs at a designed time and location can include a location and time of an author; meaning the bona-fides can indicate whether an author was present at an event or not. In another example, an electronic document can concern a medical condition, where bona fides can indicate whether an author suffers from the medical condition, has medical expertise that uniquely qualifies him/her to provide insight on the medical condition, or whether the author possesses no known specialized knowledge in regards to the medical condition.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium. In one embodiment, the present invention can also be provided as a service, such as a Web service.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

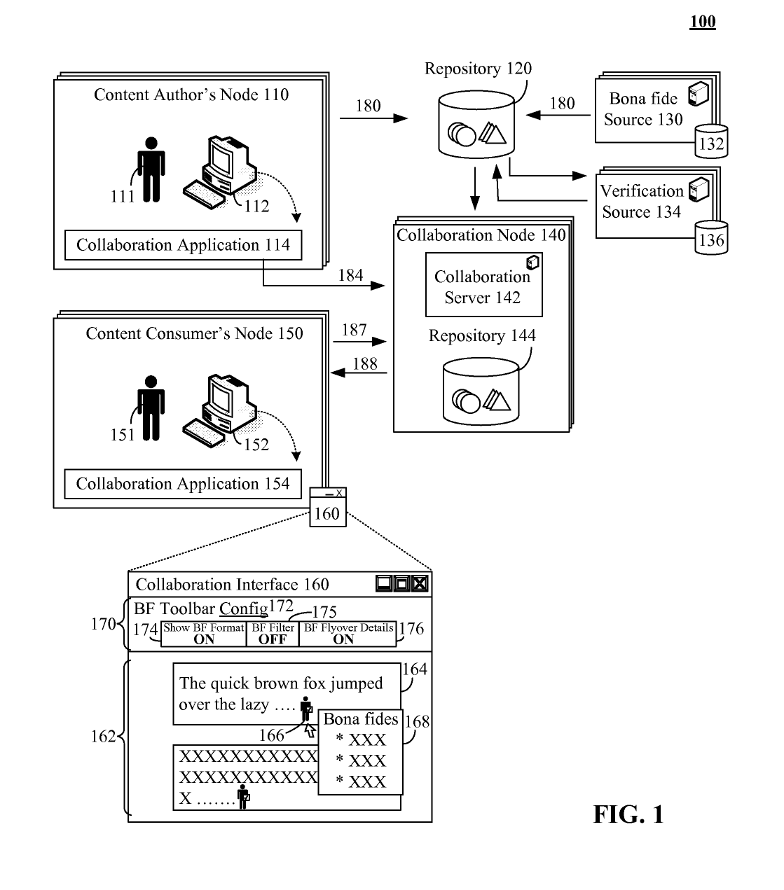

FIG. 1 is a schematic diagram of a system 100 for exposing or otherwise utilizing bona fide information in a collaborative document context in accordance with an embodiment of the inventive arrangements disclosed herein.

In system 100, content authors 111 and content consumers 151 can interact with a collaboration node 140, which provides one or more collaboration services and/or functions for collaborating upon electronic documents. An electronic document can include a Web 2.0 document (e.g., Wiki, Blog, Mash-up, a social networking document, a discussion thread, a chat forum, a shared interactive computing space, etc.), a business integration document (shared calendar/meeting entry, interactive knowledge repository, project management/tracking document, etc.), and other document (e.g., a version controlled document, a shared word processing document with a track-changes option, etc.). Each electronic document can include content from one or more authors 111.

Bona fide information about a content author 111 can be stored in a repository 120. The bona fide information 180 can be acquired from the author 111 and/or by one or more other data sources 130. Various techniques can be utilized to obtain the bona fide information 180, which can include but are not limited to interrogating a profile database with an entry for the author 111, by interactive questioning the author 111, by obtaining profile data maintained on a client-side computing device 112, by determining the author's location, and the like. In one embodiment, techniques can be implemented to infer the author's 111 identity automatically (i.e., using a geocoding technique to determine a user identity based upon an IP address of device 112), at which point author 111 specific information can be obtained (i.e., by interrogating a profile database based upon user identity).

Bona fide information can be optionally verified by a verification source 134. When content 184 is provided by an author 111, a collaboration node 140 can associate the author-provided content 184 with bona fide information of the author 111, which can be provided with content 184 or acquired (from repository 120, for example) responsive to receipt of content 184.

Content consumers 151 can request 187 documents from collaboration server 142, which accesses requested content from repository 144 and provides it in response 188. The response 188 can include an indication of bona fide information concerning content authors, as well as the requested document(s). Upon receipt, a collaboration application 154 can present the response 188 within a user interface 160. Interface 160 can include a document presentation section 162, within which content from one or more authors 111 is presented to content consumer 151. In one embodiment, when author specific 164 content is presented, an indicator 166 associated with the bona fides of the author 111 can be shown.

This indication 166 can include, but is not limited to, use of a distinctive text color, font style, font characteristic (e.g., bold, underline, italics, transparency), font size, a footnote, a graphic, a textual comment, and the like. In one embodiment, the content associated with the indicator 166 can itself be changed to reflect an existence and/or details of the bona fides of the content author 111. In one embodiment, a style sheet or other rules of render can be presented to the content consumer, where the style sheet/rules may not be changed by the consumer 151. In another embodiment, style sheet/rules for rendering can be changed or partially changed by the content consumer 151. The style sheet/rules may render the response 188 so that the indication 166 is presented. In one embodiment, multiple different style sheets/rules can exist, which are selectively applied or selected for rendering based at least in part upon semantic values/characteristics of the content being rendered.

The indication 166 can convey semantic meaning to consumer 151 concerning the bona fides of the author 111. For example, a color yellow can indicate that a trustworthiness of the author 111 (based upon the bona fides) is suspect, where a green can indicate a relatively high trustworthiness is associated with the comment 164. In one embodiment, additional more detailed information concerning an author's bona fides can be optionally presented. For example, a fly-over window 168 can pop-up when a pointer hovers over section of the displayed content 164 for a previously designated duration. Detail window 168 can alternatively be implemented as a pop-up window, as a delineated section of interface 160, such as a frame, as an in-text comment, etc. The details 168 can include any of a variety of datum depending upon implementation desires. In one embodiment, detail level and elements presented within a window 168 can be user configured.

In one embodiment, interface 160 can include a number of configuration 172 options for tailoring behavior of bona fide aspects of the interface 160. For example, a toolbar 170 can be included that allows a user to selectively adjust behavior by selecting included options 174-176. One option 174, for example, can enabled or disable distinctive formatting for bona fides. That is, the option 174 can turn indication 166 on/off. Another option 175 can enable/disable a content filter based upon bona fides of the author 111. For example, the filter 175 can automatically suppress content from authors 111 believed to be below a user selected trustworthiness level. Option 176 can enable/disable and configure presentation options for bona fide details 168. As shown, details are enabled in a fly-over mode.

In one embodiment, bona fide functionality can be provided as a service, such as a Web service. For example, a user can select authored content from within a user interface and can then select an interface control that is linked to the bona fide service. Selection of the control can initiate programmatic actions to identity an author of the selected content. The author identity and the selected content itself (needed when relevant bona fides are dependent upon semantic content) can be conveyed to a server, which determines bona fides and conveys an indication of the determined bona fides back to the requesting computing device 152. In the example, the bona fide service can be functionally independent of programmatic operations performed by the collaboration node 140.

In one embodiment, the collaboration interface 160 can be a Web browser interface, where bona fide functionality can be implemented as a plug-in or extension to the Web browser. For instance, one or more bona fide options can be included in a Web search toolbar, such as the GOOGLE toolbar. In this case, the bona fide information can be provided as an overlay presented proximate to authored content, when a bona fide presentation option is enabled.

A content author node 110 that interacts via the network can include a content author 111, a computing device 112 used by the author 111, and a collaboration application 114 executing upon device 112. A content consumer node 150 can include a computing device 152 hosting collaboration application 154, where a consumer 151 interacts with the network using device 152. Each computing device 112, 152, and server 142 (plus inherent servers in sources 130, 134) can include hardware, software, and firmware. The hardware can include one or more processors, a volatile memory, a non-volatile memory, a network adaptor, and other components connected via a bus. The software/firmware can include programmatic instructions stored in a storage medium which can be executed and/or otherwise utilized by the hardware.

As used herein, bona fides represent information (e.g., credentials, particulars, characteristics, details, educational background, work experience, etc.) concerning a content author 111 that is related to an aspect of the author 111 as a content provider, which is indicative of a quality of content provided. Bona fides can include, for example, an indication of whether an author 111 was present at an event which he/she is writing about. In such a case, the bona fides will include time and location datum for the author 111, which are compared against time and location datum of an event, which assumes semantics of content associated with the bona fides is for an event. In one embodiment, time/location bona fide data can be obtained from a trustworthy bona fide source 130, such as from mobile telephone database, which can validate that a customer's phone was located within a particular telecommunications cell (e.g., geographic location) at a particular time.

Bona fides can include confidential data, which are used to assess an accuracy of provided content and/or a suitability of the author 111 to provide the content, where the confidential data is not displayable to others. In one embodiment, non-confidential bona fide data can be displayed in full to consumers 151. Bona fides can be represented in any manner, such as straight characteristics, a score or rating representing an author's 111 suitability for providing a type of content, a score or rating representing a likelihood that author 111 provided content is accurate, and the like.

An electronic document can represent any type of digitally encoded content, which can be created by an author 111 and provided to a consumer 151. The electronic document, for example, can be a word processing document, an email message, a chat conversion, a blog entry, a pop-up comment, a footnote, a media file, and the like. Each electronic document can include one or more discrete sections, where each section can be associated with a different author 111. An electronic document can include text, sound, video, graphics, and/or other types and formats of digital content.

Bona fide source can be any source able to provide bona fide 180 data of an author 111. The source 130 can include the author 111 himself/herself, when the bona fide information is provided as input. The source 130 can include a data repository including a profile of an author 111. The source 130 can be a set of electronic documents, which can be data mined for author 111 data.

Verification source 134 can include any source able to ascertain an accuracy of likelihood of accuracy of author 111 associated information or of content 184 provided by an author. Verification sources 134 can include trusted sources of personal information, such as government maintained databases, utility or other service provider repositories, business maintained information sources, and the like. One or more verification sources 134 can be credentialing authorities, such as a source conforming to the HIGGINS TRUST FRAMEWORK, currently detailed at www.eclipse.org/higgins/. Verification sources 134 can also include rating information or input from a community of users, such as content consumers 151, regarding their belief of the accuracy of author 111 information or content 184. The bona fide source 130 and the verification source 134 can each include any combination of hardware, software, and firmware components for storing, managing, and processing digital information. Each source 130, 134 can also include a set of human agents, who provide information concerning an author 111, which can be captured and stored in repository 120.

Collaboration application 114, 154 can include any software/firmware set of programmatic instructions able to be stored on a storage medium and executed by a machine, which permit electronic documents and/or content 184 to be created, edited, and/or shared among a set of users. The set of users can include one or more authors 111 and one or more content consumers 151. Further, authors 111 of some collaborative content 184 can be consumers 151 of other content 187, and vice versa. In different embodiments, collaborative applications 114, 154 can be client-side interfaces for interacting with a collaboration server 142 or can be peer-to-peer applications permitting direct communications among devices 112, 152 of authors 111 and consumers 151. Collaboration applications 114, 154 can include, but are not limited to, social networking applications, WIKIs, BLOGs, MASH-UPs, Chat forums, IM applications, email applications, calendaring or meeting applications, Voice Over Internet Protocol (VoIP) applications, net meeting spaces, shared computing spaces, and the like.

Collaboration server 142 can be any set of computing devices and related software that facilitate collaboration on electronic documents. Server 142 can include, but is not limited to, Web server functionality, communication server (e.g., email, IM, chat, etc.) functionality, data mining functionality, and the like.

Collaboration interface 160 can include any interface presentable upon a computing device 112 or 152, which permits user interactions. These interactions can include content authoring, editing, commenting, viewing, searching, filtering, and other such functions. In different embodiments, interface 160 can be implemented as a graphical user interface (GUI), a text user interface (TUI), a voice user interface (VUI), a multimodal interface, and the like. Bona-fide tools 170 of interface 160 can be implemented as an extension or plug-in to a base application interface and/or can be a non-separable integral part of the interface 160. Interface 160 can be a browser interface, a rich internet interface, a network-enabled desktop gadget interface, an interface of a stand-alone software application having collaborative capabilities, and the like. In one embodiment, the interface 160 can be customized by a user 111, 151 to behave in accordance with user defined and/or user specific preferences.

Each repository 120 or data store 132, 136, 144 of system 100 can be a physical or virtual storage space configured to store digital information. Each repository 120 or data store 132, 136, 144 can be physically implemented within any type of hardware including, but not limited to, a magnetic disk, an optical disk, a semiconductor memory, a digitally encoded plastic memory, a holographic memory, or any other recording medium. Each repository 120 or data store 132, 136, 144 can be a stand-alone storage unit as well as a storage unit formed from a plurality of physical devices. Additionally, information can be stored within each repository 120 or data store 132, 136, 144 in a variety of manners. For example, information can be stored within a database structure or can be stored within one or more files of a file storage system, where each file may or may not be indexed for information searching purposes. Further, each repository 120 or data store 132, 136, 144 can utilize one or more encryption mechanisms to protect stored information from unauthorized access. Repositories may be geographically separated (e.g., in different data centers, associated with different business entities).

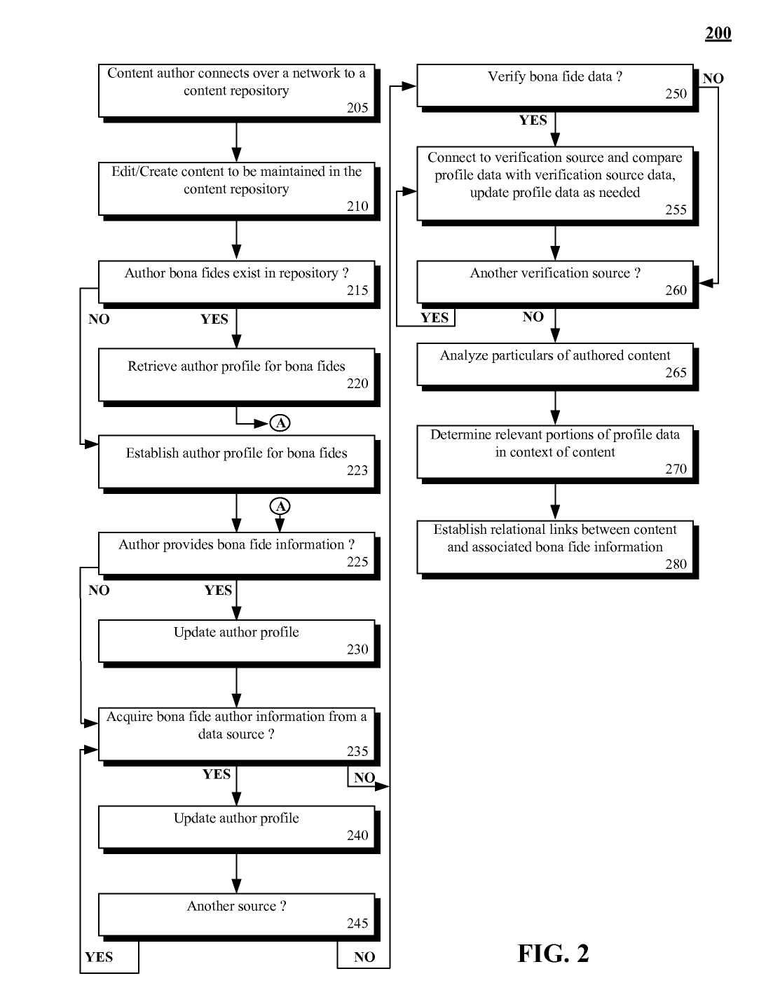

FIG. 2 is a flow chart of a method 200 for acquiring bona fide information of a content author and associating the bona fide data with related content stored in a shared content repository in accordance with an embodiment of the inventive arrangements disclosed herein. Method 200 can be performed in context of system 100.

Method 200 can begin in step 205, where a content author can connect to a content repository containing shared electronic documents. This connection can occur over a network and the content repository can be remotely located from a computing device with which the content author interacts. In step 210, the content author can edit and/or create content to be maintained in the content repository.

A determination of whether bona fide information for the author exists in the repository or in a data store indexed against content of the repository can be made in step 215. If such information exits, the author profile for the content author can be retrieved, as shown by step 220. The author profile refers to a set of information associated with the author, which includes maintained bona fide data, which is able to be linked to authored content. If no author profile exists, a new profile for the author can be established in step 223.

In step 225, the content author can optionally provide bona fide information, which when provided can update the author profile, as shown by step 230. Bona fide author information can also be acquired from one or more data sources, as shown by step 235. When a data source for author information is obtained, author profile information can be updated appropriately, as shown by step 240. Multiple sources can be utilized, as indicated by step 245.

In step 250, bona fide data can be optionally verified. Verification can involve connecting to a verification source and comparing profile data with data maintained within the verification source, as shown by step 255. Profile data can be updated to reflect results of verification actions. Multiple verification sources can be utilized, as shown by step 260.

In step 265, particulars of the authored content can be analyzed. In step 270, relevant portions of the profile data can be determined in context of the analyzed content. For example, if the authored content contains semantic information pertaining to a medical condition, author profile information indicating whether the author possessing medical expertise and/or has suffered from the medical condition in question would be considered relevant in context. In step 280, relational links, which can be relational database links and/or other indexing links, can be established between the authored content and the associated bona fide information.

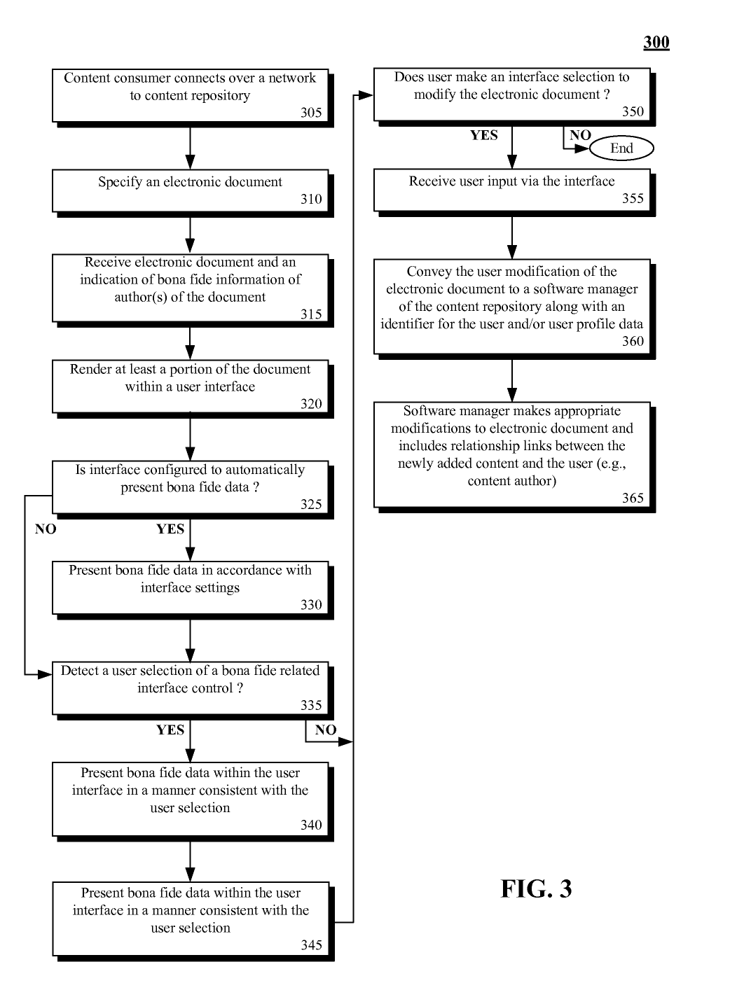

FIG. 3 is a flow chart of a method 300 for presenting bona fide data of content authors to content consumers in accordance with an embodiment of the inventive arrangements disclosed herein. Method 300 can be used in conjunction with method 200 and can be performed in context of system 100.

Method 300 can begin in step 305, when a content consumer accesses a shared content repository. This can occur over a network from using a client remotely located from a server that manages the repository. In step 310, an identifier, such as a file name, for desired electronic document can be specified. In step 315, the electronic document can be found in the repository and sent to the content consumer, who receives the electronic document along with an indication of bona fide information related to at least one of the set of content authors who provided content of the electronic document. The bona fide information can be sent from the same source/server that provided the content or can be provided from a different source/server, which is also connected to the network. When different servers are used, intra server communications can occur, such as the content server sending a request to the bona fide server to provide the content consumer with bona fide data related to the content and authors of the electronic document.

In step 320, at least a portion of the document can be rendered within a user interface used by the content consumer. In one embodiment, this user interface can include a Web browser, but the disclosure is not so limited and any user interface can be utilized.

The interface can be optionally configured to automatically present bona fide data, as shown by step 325. If such a setting exists and is enabled, then bona fide data or indicators related to the bona fide data can be presented in accordance with interface settings, as shown by step 330.

In step 335, a user selection of a bona fide related control may be detected. If so, the method progresses to step 340, where bona fide data is presented within the user interface in a manner consistent with the user selection, as shown by step 345.

For example, in one embodiment, an interface can be configured to present an indicative icon proximate to content, when bona fide data is available for the corresponding content, as illustrated in interface 160 of FIG. 1. This can assume that step 325 evaluates positively and that the interface is configured to automatically present an indicator, but not details, of bona fide information. Selection of the icon via a pointer movement/clicking action can be a user selection (i.e., a positive evaluation of step 335) that results in details of the bona fides being presented in a pop-up window (e.g., as shown by item 168 of FIG. 1). This example is just one contemplated implementation and the disclosure is not to be construed as limited in this regard. For instance, other indicators besides an icon (e.g., characteristic font, font size, color, highlighting, etc.) can be utilized and other presentation mechanisms besides a pop-up (e.g., in-line embedding of bona fide data, presentation of bona fide data in a special section/frame of the interface, etc.) for showing bona fide details can be utilized.

In one embodiment, the content consumer, who is presented with the electronic document and bona fide information may also choose to modify the electronic document, thus becoming a content author as well as a content consumer. This situation is shown by step 350, which progresses to step 355 when the user makes a modification via the interface. In step 360, the user modification can be conveyed to server or software manager of a server that manages the content repository. An indicator of the user's identity and/or a user profile identifier can also be conveyed to the content repository. In step 365, the software manager can make appropriate modifications to the electronic document and can include relationship links between the newly added content and the user. Steps 355-365 can progress in accordance with method 200, which shows the content authoring process where bona fide data is maintained in more detail than expressed in method 300.

The diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for document collaboration comprising:
determining content to be included within an electronic document associated with a content author;
determining bona fide information of the content author;
receiving a request for the electronic document by at least one content consumer; and
responsive to the request, providing a copy of the requested electronic document to the content consumer; and
providing the content consumer with an indication of the bona fide information related to at least one content author associated with the electronic document.

2. The method of claim 1, wherein the indication of the bona fide information is provided responsive to the request.

3. The method of claim 1, further comprising:
incorporating the content and the indication of the bona fide information within the electronic document.

4. The method of claim 1, wherein the provided copy of the electronic document and the indication of the bona fide information are included in at least one document formatted to be presentable within a standard browser application.

5. The method of claim 1, wherein the electronic document is formatted so that a user selection of a control within the user interface results in a presentation of the indication of the bona fide information within the user interface, where before the user selection the indication of the bona fide information was not presented within the user interface.

6. The method of claim 1, further comprising:
verifying an accuracy of the bona fide information utilizing a crediting authority; and
including data indicative of results of the verifying within the indication of the bona fide information.

7. The method of claim 1, further comprising:
determining a subset of bona fide information for a content author relevant to semantics of the content which was provided by the content author, wherein an indication of only the subset of bona fide information is provided in conjunction of the copy of the electronic document responsive to the received request.

8. The method of claim 1, wherein a network server receives the content, determines the bona fide information, incorporates the content, stores the electronic document and the determined bona fide information, receives the request, and provides the copy of the stored electronic document and the copy of the bona fide information, wherein each of the content author and the content consumers utilize a client computing device connected to a network to which the network server is communicatively linked to interact with the network server utilizing standard communication protocols.

9. The method of claim 1, further comprising:
presenting the indication of the bona fide information within a user interface, wherein the indication is visually depicted within the user interface as at least one of a distinctive text color, font style, font characteristic, font size, a footnote, a graphic, and a textual comment.

10. The method of claim 1, further comprising:
obtaining the bona fides from at least one of:
content author provided input;
an interrogated profile database;
records obtained by querying a data source based upon an IP address of a machine used by a content author;
results from interactively questioning the content author;
results from querying a mobile phone provider's database records;
an identity service; and
records obtained by querying a data source based upon an identity of a content author.

11. The method of claim 1, wherein the electronic document is a WIKI, and wherein a WIKI server determines the bona fide information, receives a request for the electronic document, provides the copy of the requested electronic document to the content consumer, and provides the content consumer with the indication of the bona fide information.

12. A computer program product for document collaboration comprising a computer usable medium having computer usable program code embodied therewith, the computer usable program code comprising:
computer usable program code configured to determine content to be included within an electronic document associated with a content author;
computer usable program code configured to determine bona fide information of the content author;
computer usable program code configured to receive a request for the electronic document by at least one content consumer; and
responsive to the request, providing a copy of the requested electronic document to the content consumer; and
computer usable program code configured to provide the content consumer with an indication of the bona fide information related to at least one content author associated with the electronic document.

13. The computer program product of claim 12, further comprising:
computer usable program code configured to verify an accuracy of the bona fide information utilizing a crediting authority; and
computer usable program code configured to include data indicative of results of the verifying within the indication of the bona fide information.

14. The computer program product of claim 12, further comprising:
computer usable program code configured to determine a subset of bona fide information for a content author relevant to semantics of the content which was provided by the content author, wherein an indication of only the subset of bona fide information is provided in conjunction of the copy of the electronic document responsive to the received request.

15. A system for document collaboration comprising:
a collaboration repository, which comprises a storage medium, and which is configured to maintain a plurality of shared electronic documents, wherein each of the shared electronic documents comprises content provided by at least one content author, wherein a linkage is maintained between content of each electronic document and a corresponding content author;
a bona fide repository, which comprises a storage medium, and which is configured to maintain bona fide information of content authors; and
a collaboration server configured to provide electronic documents from the collaboration repository to content consumers responsive to document requests, wherein the collaboration server is configured to further provide bona fide data of content authors linked to provided electronic documents responsive to document requests.

16. The system of claim 15, further comprising:
at least one verification source configured to verify accuracy of bona fide information maintained in the bona fide repository.

17. The system of claim 15, further comprising:
at least one bona fide source functionally independent of the collaboration server and the bona fide repository, wherein the at least one bona fide source comprises a profile database configured to maintain personal information on a plurality of individuals, wherein at least a portion of the bona fide information of the content authors maintained in the bona fide repository is acquired from at least one bona fide source.

18. The system of claim 15, wherein the collaboration server is a Web 2.0 server, wherein each of the shared electronic documents are Web 2.0 documents.

19. The system of claim 15, wherein the collaboration server is a WIKI server, wherein each of the shared electronic documents are WIKI documents.

20. The system of claim 15, wherein the collaboration server is configured to generate Web browser renderable markup documents, wherein a single generated markup document integrates electronic document content and an indication of related bona fides associated with at least one content author.
